(19) United States
(12) Patent Application Publication
(10) Pub. No.: US 2007/0070895 A1
(43) Pub. Date: Mar. 29, 2007

(54) Scaleable channel scheduler system and method

(76) Inventor: Paolo Narvaez, Sunnyvale, CA (US)

Correspondence Address: PILLSBURY WINTHROP SHAW PITTMAN LLP, P.O. BOX 10500, MCLEAN, VA, 22102, US

(21) Appl. No.: 11/236,324

(22) Filed: Sep. 26, 2005

(51) Int. Cl. H04L 12/26

(52) U.S. Cl. 370/230

(57) ABSTRACT

A data flow egress scheduler and shaper provides multiple levels of scheduling for data packets exiting communications devices. A classifier separates data from multiple sources by data flow and by priority within a data flow. An output controller requests a data packet for transmission and the scheduler selects a next available highest priority packet from a next in sequence data flow or from a management data queue. The shaper can control the rates of classes of service to be scheduled by the device. The scheduler typically comprises three levels of scheduling. Large numbers of output ports can be implemented in a single device by a virtual scheduler that services each data flow, output port and data source as a shared component, maintain context for groups of schedulers and data flows.

### BACKGROUND OF THE INVENTION

1. Field of the Invention

Generally, the present invention relates to the telecommunications and digital networking. More specifically, the present invention relates to the prioritization and scheduling of packets exiting a heterogeneous data networking device.

2. Description of Related Art

Certain network devices may be classified as heterogeneous in that they may accept data of many different types and forward such data (for egress) in many different formats or over different types of transmission mechanisms. Examples of such devices include translating gateways which unpackage data in one format and repackage it in yet another format. When such devices merely forward data from point to point, there is little need to classify packets that arrive at such devices. However, in devices where there are multiple types of ports which may act as both ingress and egress ports, and further in devices where physical ports may be sectioned into many logical ports, there is a need for packet classification. In some of these devices, where the devices also provision multicasting of data, packets must often be stored in queues or memories so that they can be read in turn by all of the multicast members (e.g. ports) for which they are destined.

FIG. 1 illustrates a heterogeneous network environment which provides different types of services and marries different transport mechanisms. A network ring 100 may include a high capacity network such as a SONET ring and usually provides service to more than one customer. Such customers may distribute the service they receive to one or more nodes behind their own internal network. FIG. 1 shows nodes 110, 120, 130, 140, 150 and 160. Nodes 140 and 150 are accessed via the same Customer Premises Equipment (CPE) network device 180 while the other nodes are shown directly accessing the ring 100. CPE 180 may be a gateway which apportions transport mechanisms such as Ethernet or PDH (such as a T1 or T3 line) over the ring 100 making use of the bandwidth given thereby. As mentioned above, ring 100 is a carrier-class network which may have a very large bandwidth such as 2.5 Gb/s. As such, ring 100 is not like a typical Local Area Network or even a point-to-point leased line.

While network elements could simply be built with many different physical line cards and large memories, such cost may be prohibitive to a customer. Further, where the customer seeks to utilize many different channels or logical ports over the same physical ingress or egress port, such solutions do not scale very well and increase the cost and complexity of the CPE dramatically. Recently, there are efforts underway to provide scalable network elements that can operate on less hardware and thus, with less cost and complexity than their predecessors but still provide better performance. However, the heterogeneous nature of the networks increase the complexity of the hardware required.

In particular, heterogeneous networks typically service data with varying expectations of bandwidth and priority. A data flow, comprising data received from a certain source, may be assigned a priority, a bandwidth allocation and other attributes that describe a class of service for the data flow. Typically a plurality of data flows is directed for forwarding and a scheduling system must select between the flows to share bandwidth in accordance with contracted or assigned service levels. As the quantity of data flows and service levels increase, so the complexity of hardware required to implement the scheduler increases.

### BRIEF SUMMARY OF THE INVENTION

The invention is directed to a system and method for efficient scheduling of user flows in data redirection devices comprising logical and physical network ports. Embodiments of the invention include scheduling algorithms including algorithms for prioritizing certain data flows and combinations of data flows. Additionally, embodiments of the invention includes a plurality of different queues associated with the data flows. Further, the invention provides for per-output-port shaping that is typically performed to shape traffic characteristics for each port.

In some embodiments, a plurality of schedulers are arranged to select packets for transmission based on fairness-based and priority-based scheduling. Further, the plurality of schedulers implement desired service level schemes that permit allocation of bandwidth according to service level guarantees of maximum and minimum bandwidths per flow.

In one example, an embodiment of the invention provides a scheduler that implements a Deficit Weighted Round Robin scheme (“DRR”) for all user flows directed to available egress ports.

Embodiments of the invention provide a virtual scheduler that can reduce complexity of hardware required to implement the invention. The virtual scheduler can maintain context information for each logical and physical port, for each data flow and for each instance of DRR and priority based schedulers. The virtual scheduler can acquire context information for a portion of the scheduling system, executes scheduling algorithms and causes the context of the scheduling portion to be updated before moving to another scheduling portion. In many embodiments, the virtual scheduler responds to a scheduling request (typically received from a scheduling pipeline) by loading relevant context from storage and executing a desired scheduling operation based on the loaded context. The loaded context can include configuration provided by a user, status of output port, priorities and other of scheduling information. Context can be stored for all of the ports in the memory of a data redirection device. By storing context information in memory, a single hardware implementing the scheduling algorithm can be utilized for all flows.

A fixed number of user flows can be assigned to each port. For the purposes of this discussion, a user flow which having at least one packet waiting in its queue will be called an “active” flow, while those flows without any packets waiting in their queues will be called “inactive.” The DRR scheduling scheme checks each of the active flows in turn to see whether each has enough “credits” to send the packet at the head of that flow. If so, the packet is output to the port designated for that flow. If there are not enough credits, the credit level of those active flows are incremented and checking of other active flows continues in a repetitive manner.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a drawing illustrating a multimedia network ring;

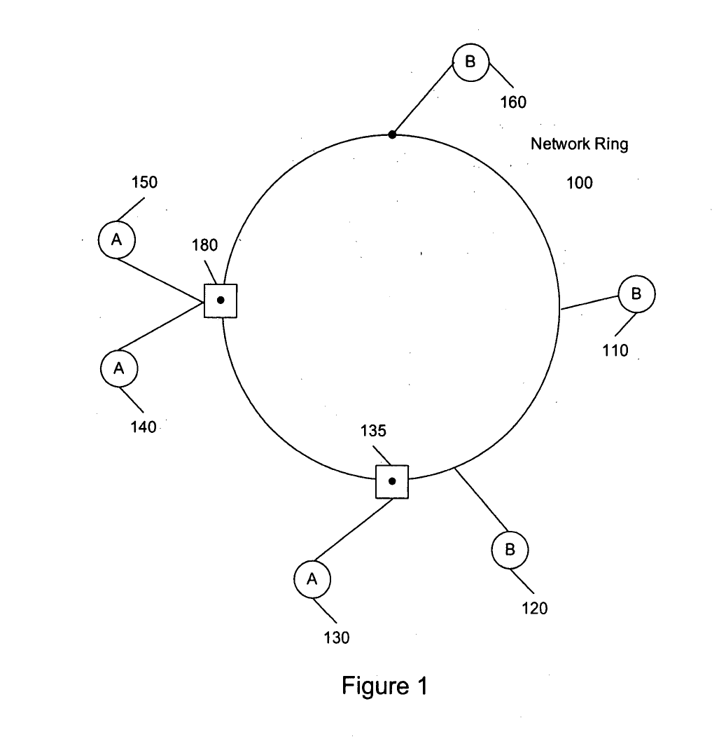

FIG. 2 is a drawing showing an example of scheduler in one embodiment of the present invention;

FIG. 3 is a drawing illustrating the use of a linked list in certain embodiments;

FIG. 4 is a flowchart illustrating scheduling activity in certain embodiments; and

FIG. 5 is a drawing illustrating shaping in certain embodiments.

### DETAILED DESCRIPTION OF THE INVENTION

Embodiments of the present invention will now be described in detail with reference to the drawings, which are provided as illustrative examples so as to enable those skilled in the art to practice the invention. Notably, the figures and examples below are not meant to limit the scope of the present invention. In the drawings, like components, services, applications, and steps are designated by like reference numerals throughout the various figures. Where certain elements of these embodiments can be partially or fully implemented using known components, only those portions of such known components that are necessary for an understanding of the present invention will be described, and detailed descriptions of other portions of such known components will be omitted so as not to obscure the invention. Further, the present invention encompasses present and future known equivalents to the components referred to herein by way of illustration.

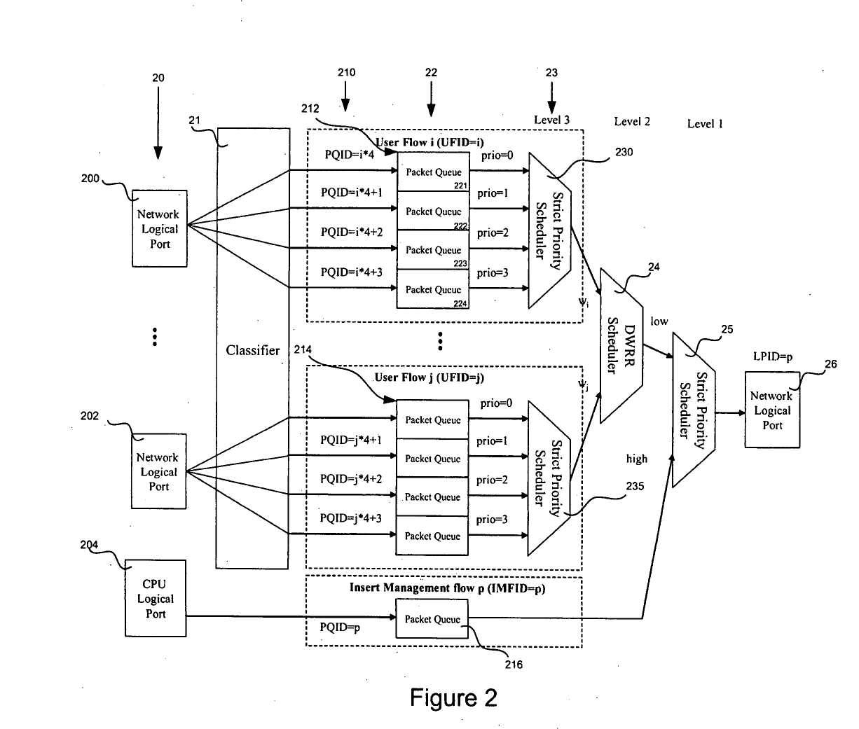

Referring to FIG. 2, the flow of packets in one example of an embodiment of the invention is illustrated. An egress packet scheduler and shaper is generally depicted as processing data packets exiting a communications device (not shown). In the example, three primary processing levels can be defined that operate together to combine packets received from one or more input ports indicated generally at 20 for transmission to an output port 26. It will be appreciated that FIG. 2 provides a simplified example that includes a sole output port 26 for clarity of discussion and that in certain embodiments, a typical implementation includes a plurality of output ports 26. In the example, output control (not shown) typically requests a next packet for transmission from level 1 scheduler 25. Level 1 scheduler 25 determines which of plural level 2 schedulers 24 or management flow queues 216 should provide the next packet for transmission. Where a level 2 scheduler 24 is solicited for a packet, the level 2 scheduler 24 determines which of a plurality of associated level 3 schedulers 230 and 235 should provide the packet. The selected level 3 scheduler 230 and 235 selects a packet from one of the packet queues 22 feeding the selected level 3 scheduler 230, 235. Thus, it will be appreciated that the process of scheduling is typically initiated by request from the output control associated with an output port 26. However, to better comprehend the scheduling schemes implemented in the example, the scheduling process be presented in reverse order, tracking data flow from input ports 200, 202, 204 to the output port 26.

Data flows typically comprise packets formatted for transmission over various media including, for example, an Ethernet network. Packets in the data flows can be prioritized based on factors including source of the packets, nature of the packets, content of the packets, statistical analysis of data traffic associated with the data flows, configuration information related to the system and information related to upstream and downstream traffic.

In the example depicted in FIG. 2, each of level 3 schedulers 230 and 235 prioritizes packets from a single data flow using one or more scheduling algorithms, typically a strict priority algorithm. Level 2 scheduler 24 typically selects prioritized packets from the plurality of level 3 schedulers where each level 3 scheduler 230 and 235 is associated with a single data flow. A level 1 scheduler 25 selects packets from one of a plurality of level 2 schedulers 24 and one or more management data packet queues 216 to provide a next packet for transmission through output port 26. In accordance with system configuration and user requirements, level 3 and level 2 schedulers may implement any appropriate scheduling scheme including combinations of priority-based schemes and fairness-based schemes such as DRR. The level 1 scheduler 25, can use a combination of fairness-based and strict priority schedulers and may implement per-output port shaping to shape traffic characteristics for each port 26. In the example shown, 2048 user flows are assigned to each port and to one of four classes of traffic, each port and class having its own shaping characteristics.

Continuing with the example illustrated by FIG. 2, additional components are provided to facilitate and optimize processing. These additional components can include a classifier 21, a plurality of packet queues 22 and various optional intermediate queues (not shown). Packets arriving at an input port 200 and 202 may be enqueued in an intermediate queue (not shown) associated with the input 200 and 202. The arriving packets are typically classified in a classifier 21 that sorts packets by source, destination, priority and other attributes and characteristics associated with a data flow. Classified packets, indicated generally at 210, can then be enqueued in one of a plurality of packet queues 22 where each packet queue 22 is associated with a data flow. Typically, a packet queue 22 is provided for each priority level within a data flow and packet queues 22 are typically associated with only one data flow. In the example, packets are directed to related groups of four queues 212, 214 and 216 associated with data flows i and j or with a data flow for management packets. Each member of a group of queues 212, 214 and 216 typically receives packets from a single data flow with a selected priority level. For example, data flow i is depicted as having four packet queues 221-224 in which each of the four packet queues 221-224 receives packets having a designated priority where packets having priority 0 are assigned to a packet queue 221 associated with priority 0 data and so on. It will be appreciated that the classification and prioritization of packets can be used to mix data from a plurality of sources where the data includes combinations high and low priority data types including, for example, highly deterministic data such as video streaming data that may be directed to a highest priority port 22 and non-deterministic data, such as certain file transfers, that may be directed to a lowest priority port 25.

In certain embodiments, level 3 schedulers 230 and 235 implement a strict priority algorithm to select a next available highest priority packet in response to a request received from a level 2 scheduler 24. Where multiple packets have a same highest priority, the algorithm may select between equal priority packets using a fairness-based priority scheme such as a first-in/first-out scheme or a round-robin scheme. Each level 3 scheduler 230 and 235 is typically associated with a data flow and selects packets from among the group of packet queues 212 and 214 associated with the data flow. In certain embodiments, each packet queue in the group of packet queues 212 and 214 is associated with a priority and the level 3 scheduler selects the next available, highest priority packet for forwarding. In certain embodiments, at least some of the packet queues in the group of packet queues 212 and 214 have a common priority and a fairness-based scheme may be used to select the next packet for forwarding. Selection of a next available packet can be made by polling queues in sequence of priority or in sequence determined by a predetermined schedule. Selection of a next available packet may also be made based on flags or counters indicating whether the queue contains one or more available packets or indicating current capacity of the queue.

It will be appreciated that other priority-based scheduling algorithms may be implemented by level 3 schedulers 230 and 235 and that in some embodiments, non-priority based algorithms may be combined in one or more of level 3 schedulers 230 and 235. Further, level 3 schedulers 230 and 235 can be implemented using non-priority based algorithms. Certain embodiments of the invention provide combinations of level 3 schedulers 230 and 235 implementing different scheduling algorithms and combinations of scheduling algorithms including priority-based, fairness-based, deterministic and non-deterministic algorithms.

In certain embodiments, level 2 schedulers 24 use a Deficit Weighted Round Robin scheme (“DRR”) scheduling scheme for selecting a level 3 scheduler 230 and 235 to provide a next packet for forwarding. In the example, the level 2 schedulers 24 receive a data flow comprising prioritized packets from each of the level 3 schedulers 230 and 235. In certain embodiments, the prioritized packets can be queued until the prioritized packets can be forwarded from the second level processor 40. Certain embodiments of the invention provide combinations of level 2 schedulers 24 implementing different scheduling algorithms and combinations of scheduling algorithms including priority-based, fairness-based, deterministic and non-deterministic algorithms.

As used in certain embodiments, DRR algorithms are based on a concept of service rounds in which, for each service round, a data flow (i.e. data sourced from a level 3 scheduler 230 and 235) having one or more packets available for transmission is allowed to transmit up to a selected quantity of bytes. A data flow having one or more available packets is hereinafter referred to as an “active flow” and a data flow having no available packets is hereinafter referred to as an “idle flow.”

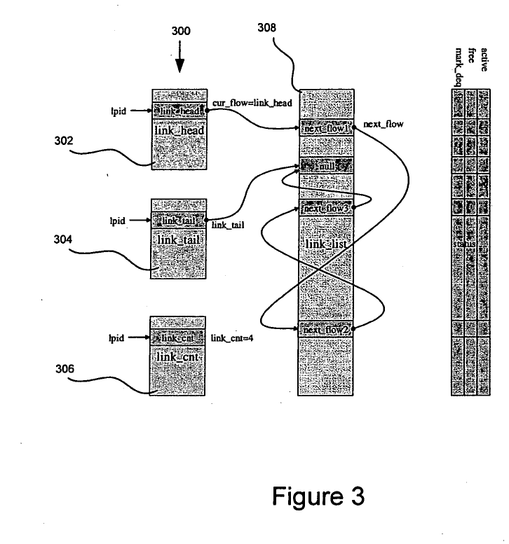

As illustrated in FIG. 3 with continued reference to FIG. 2, in one example of a level 2 scheduler 24, identifiers 303, 305, 307 reference packets 302, 304 and 306 that are provided by any of a plurality of level 3 schedulers 230 and 235. Identifiers 303, 305, 307 may be added to a linked list 308 when the level 3 scheduler 230 and 235 indicates that it has one or more prioritized packets 300 available for transmission. The linked list 308 of the example is typically configured as a circular list with an index pointing to a current element and a last element in the list 308 linked to a first element in the list 308. The list 308 may be parsed in any order necessary to achieve the objectives of the scheduling scheme adopted for the level 2 scheduler 24 but is typically parsed sequentially with a current list element identifying a next list element. New identifiers of a level 3 scheduler are typically added to the tail of the linked list 308 but, in certain embodiments, references can be added to other places in the linked list 308. It will be appreciated that the example of the linked list 308 is provided of a system that offers flexibility in scheduling, initialization, prioritization and weighting accorded each of the level 3 schedulers 230 and 235 as required by the level 2 scheduling scheme.

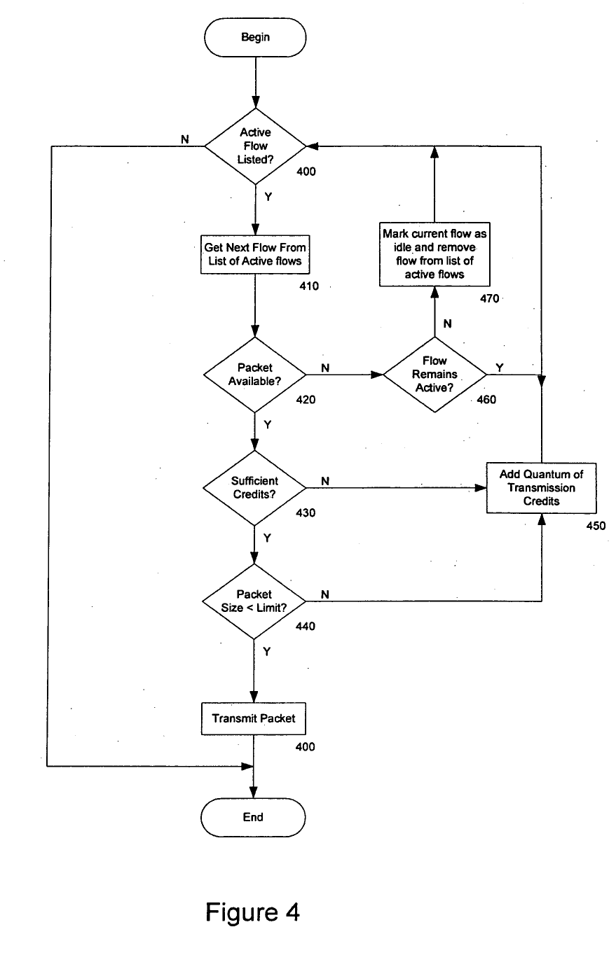

Referring now to the flow chart of FIG. 4 together with FIGS. 2 and 3, an example of a level 2 scheduling scheme implemented using a DRR algorithm is illustrated. For each level 2 scheduler 24, the DRR algorithm forwards prioritized packets from each data flow according to position of identifiers in the list or through some other desired sequencing scheme. At step 400, if an active flow exists then the algorithm moves to the next in sequence queue at step 410, and so on until a prioritized packet is obtained for forwarding at step 420. At step 410, the next-in-sequence data flow is selected. It will be appreciated that in certain embodiments the DRR algorithm can select the next-in-sequence data flow from among the level 2 schedulers 24 according to order of entry of active data flows in the list 308. Other sequencing schemes can also be implemented. In a simple example, the sequence of queues can be maintained as the circular linked list 308, with each queue having a single entry. The next-in-sequence data flow is typically queried for presence of a prioritized packet for transmission.

If, at step 420, no packet is available from the next-in-sequence data flow, an assessment of activity status of the next-in-sequence data flow may be performed at step 460. In determining whether the next-in-sequence data flow can be designated as, for example, active or inactive, system configuration, system activity, configured service levels, policy and other such information may be considered as well as presence or absence of incomplete data packets in queues, devices and buffers associated with the data flow. Where it is determined that the data flow has become idle, the data flow is typically removed from the list of active data flows at step 470. It will be appreciated that in the example, when a packet becomes available in a hitherto idle flow, the data flow becomes an active flow and a certain number of transmission credits is typically assigned to the active flow.

In certain embodiments, a service quantum of the flow can be configured as a selected number of transmission credits. Transmission credits are typically measured in bytes. Upon transmitting a packet, the quantity of transmission credits available to a flow is reduced by the size of the transmitted packet. While servicing the next-in-sequence flow at step 430, a DRR or other algorithm may check sufficiency of credits associated with the next-in-sequence. Typically, an active data flow may transmit packets only if it has sufficient transmission credits available. When the flow has insufficient credits for transmission of an available packet, remaining credit can be carried over to a subsequent service round at step 450. Carried-over transmission credits are typically tracked by a deficit counter associated with each data flow. It will be appreciated that all deficit counters are typically set to zero upon system initialization. In certain embodiments, the service quantum of a data flow may be added to the deficit counter of the flow at the commencement of a service round. When a data flow becomes idle, having transmitted all waiting packets in a service round, remaining transmission credits are typically deleted and the deficit counter is reset to zero. In order to send the next available packet, the number of credits recorded in the deficit counter must generally be greater than or equal to the packet length of the available packet.

When the next-in-sequence data flow has sufficient credits to transmit its next available data packet, the size of the packet may be checked at step 440 to ensure that it may be transmitted in its entirety in the current service round. Should there be sufficient capacity to transmit the entire packet, transmission may proceed. After service, the reference 303, 305 and 307 associated with the data flow is typically moved to the tail of the linked list 308. The next active flow referenced in the linked list will then become the next-in-sequence data flow for servicing.

In certain embodiments, the level 3 scheduler 230 and 235 provides an indication that at least one complete packet is available in at least one of its associated packet queues 22. Optionally, the level 3 scheduler 230 and 235 provides other information including size of available packets and it will be appreciated that, in a simple implementation, the indicator can be the size of the smallest or largest available packet. In the latter example, where the indicator is also size information, size equal to zero would indicate no available packets. In certain embodiments, the round-robin algorithm receives size restrictions from the level 1 scheduler 25 limiting the size of packet that can be transmitted next. When such size restrictions are received, level 3 schedulers 230 and 235 are typically required to provide size information enabling the DRR algorithm to determine it the packet available in the current active flow is suitable for transmission. Thus the DRR may pass over the current active flow at step 440 if the next prioritized packet in the queue exceeds the size limitation.

In certain embodiments, one or more output ports 26 can be connected to a suitable high-speed communications medium and the one or more output ports 26 may be associated with logical channels of the high speed communications medium. Examples of high speed media include asynchronous digital hierarchy (ADH), synchronous digital hierarchy (SDH) and SONET.

In certain embodiments, per port scheduling can be handled by a shared physical scheduler such that scheduling tasks may be pipelined and wherein the shared scheduler maintains context for each of a plurality of virtual schedulers. In certain embodiments predetermined sets of flows can be configured and assigned to each class and port. For example, in one embodiment where 2048 user flows can be supported in a system, each user flow may be assigned to any combination of class and port. In another example, each of 2048 user flows can be mapped to a single port and class. Additionally, it will be appreciated that, in many embodiments, a flow will be typically assigned to only one port.

In certain embodiments, upon transmission of the last packet in a current flow, the flow remains active for a selected period of time. During this time, available service credit can be maintained for the current flow. Additionally, one or more a flags—such as a “Mark_deq” flag—may be set and the flow can be moved to the end of the active flow link list. During a next service round, where the Mark_deq flag is set and no packet is available in the current flow, then the current flow can be dequeued from the active flow link list and become inactive. Such a hysteresis function can alleviate excessive enqueuing and dequeuing of flows into and out of the active flow link list because of limited cache entries.

In certain embodiments, reserved bandwidth can be allocated to a user flow on a logical network port where the reserved bandwidth typically depends on the service quanta of all the user flows associated with the port and transmission rates provided by the port. In one example, the reserved bandwidth of flow i, Rᵢ, is given by:

$${R}_{i} = \frac{{Q}_{i}}{{\sum }_{j ∈ A} Q j} \cdot R$$

Qᵢ: Service quantum of flow i
A: Set of active flows
R: Port bandwidth

Further, in certain embodiments, the system can operate in a mode that provides classes of service. Classes of service are typically configured to allocate bandwidth at the system output 26 (see FIG. 2) to certain data flows or groups of data flows. In one example both fixed and variable bandwidth allocations for data flows may be provided. In this example, some data flows may be allocated a quantity of bandwidth that is guaranteed to be available regardless of bandwidth needed at any particular time. Data flows may be allocated a bandwidth range that has a guaranteed minimum bandwidth and a maximum possible bandwidth such that actual bandwidth provided depends on data flow requirements and bandwidth availability. Data flows may be allocated bandwidth on a priority basis such that sufficient bandwidth will be allocated to meet the requirements of high priority data flows as demanded. It will be appreciated that other classes of services may be configured as required to meet the needs of data flow types. In one example, the service quantum Qᵢ of user flow i is:
Qᵢ=Wᵢ·S
Wᵢ: Scheduling weight of flow i
S: The quantum scale factor

In a DRR algorithm, if a user flow at the head of the active list has a service quantum of less than the Maximum Transmission Unit (MTU) of a corresponding port, the user flow may not have sufficient credits to send a packet. Where insufficient credits are available, the affected user flow will typically be moved to the end of the active list for the corresponding port. Scheduling continues with the next flow in the active list. To avoid potential inefficiencies arising from multiple sequential failed scheduling attempts, many embodiments of the invention provide for a service quantum of a minimum bandwidth flow on a port to be equal or greater than the MTU for that port.

In certain embodiments, service quanta are configurable through software and it may be necessary to adjust the service quantum of one or more other flows such that the minimum bandwidth guarantees of the flows can be preserved while maintaining the value of the service quantum of the smallest bandwidth flow equal to the value of the MTU. It will be appreciated that software computations of a new set of service quantum values for all affected flows and an associated reconfiguration of system hardware can be cumbersome and may also cause transient unfairness between flows. For example, in a port that has an MTU of 1K and two flows having an assigned minimum bandwidth of 40% each, the service quanta for the two flows could be chosen to be 1K. Upon addition of a third flow with a minimum guaranteed bandwidth of 10%, the desired service quanta would be 1K for the new flow and 4K for the two existing flows.

Certain embodiments permit software configuration of a scheduling weighting factor for each user flow and a quantum scale factor associated with each logical network port as an alternative to software configuration of service quanta for user flows directly. The service quantum of a given flow can be calculated as the product of the scheduling weighting factor of that flow and the quantum scale factor for the corresponding port. Accordingly, when the flow is added to or removed from a port, or when the bandwidth of a flow is changed, it is typically sufficient to change a combination of the port scale factor and the scheduling weighting factor of the added or modified flow.

The scheduling weighting factor assigned to a given user flow can be viewed as the fraction of the port bandwidth allocated to that user flow. For example, the minimum bandwidth flow could be assigned a weighting factor of 1. Many embodiments of the invention use 16-bit unsigned integer format to represent the scheduling weighting factor. Thus, it will be appreciated that approximately 64 Kbps bandwidth allocation granularity on an OC48c port can be provided. In another example where lower speed ports are provided, 16 bits of weighting factor could allow bandwidth allocation granularity finer than 64 Kbps.

Embodiments of the invention can dynamically adapt credits, weighting factors and quanta to promote efficiencies in unusual or transitory circumstances. For example, when only one flow is active on a port, then packets from the active flow can be scheduled regardless of available DRR credit because no other flows are in competition for scheduling. In this example, the packets can be scheduled for transmission and the DRR credits are maintained unchanged until one or more additional data flows become active.

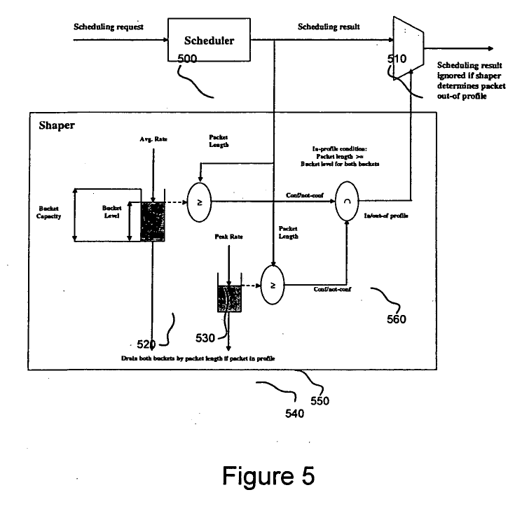

Referring to FIG. 5, certain embodiments of the invention provide traffic management. Packets queued for transmission are typically scheduled and shaped based on traffic contracts. In one example, four classes of service are associated with each logical port. A Weighted Deficit Round Robin (WDRR) algorithm 500 can be utilized to ensure minimum bandwidth guarantees for a plurality of data flows competing for a same class of service on a logical port. Data emerging from the WDRR stage is then transmitted to a single-token-bucket shaper, the shaper optionally having a work-conserving mode that allows the service to use available bandwidth. Different shaping profiles can be provided for each class of service and the output of the shaper is typically subjected to a strict priority final stage that schedules between the service classes of the logical port. The final stage additionally selects between scheduled class results and management flows associated with the logical port.

Aspects of the invention provide for packets to be subjected to input rate control (“Policing”) to ensure that the packets conform to predetermined average and peak rate thresholds. In certain embodiments, policing is implemented using is a dual token bucket algorithm. One of the token buckets can be assigned to impose a bound on the rate of the flow during its bursts of activity (“peak rate bucket”) 540, while the other bucket 520 can be used to constrain the long-term behavior of the flow (“average rate bucket”). In one example, an embodiment may support 2048 policing contexts, each context being based on flow or policing IDs.

A token bucket can be conceptualized as a container for holding a number of tokens or credits which tokens and credits represent the byte-receiving capacity of the bucket. As packets arrive, some quantity of tokens is removed from the bucket corresponding to the size of each packet. When the bucket becomes empty, it signals that the threshold represented by the bucket has been exceeded. It will be appreciated then, that two pertinent configuration parameters of a token bucket can be bucket capacity and token fill rate. The capacity of a bucket may determine a minimum number of bytes that can be sequentially received in conformance with the purpose of the bucket. The determinable number is a minimum number because bytes can continue to be received as the bucket is simultaneously being filled and, consequently, more bytes can be received than indicated by nominal bucket capacity. An arriving packet is considered conformant when the number of tokens in the bucket is greater than or equal to the byte length of the packet. If the packet is conformant, and if the packet is not dropped for other reasons (for example by the flavor of WRED implemented by the Buffer Manager), then the number of tokens held by the bucket can be decremented by the number of bytes in the packet.

The token fill rate typically determines the rate at which tokens are added to the bucket. The token bucket can remain full as long as the arrival rate of the flow is below the token fill rate. When the rate of the flow is greater that the token fill rate, the bucket will begin to drain. Should the bucket be emptied of tokens, then the rate of the allowed traffic on the flow will be limited to the token fill rate.

The present invention provides for shaping data flows. FIG. 5 illustrates an example of an implementation based on the dual token bucket concept. In certain embodiments, a token bucket shaping algorithm is implemented for each class of service and each port. The shaping algorithm is typically implemented to ensure that data flows exiting the system conform to a desired shaping profile, where the shaping profile can be used to determine a mix of packets output from the device and wherein the mix is typically selected according to relative proportions of packets associated with each of the data flows and packet type.

In certain embodiments, class-based shaping predominates. In certain embodiments, a single token bucket algorithm is implemented for shaping aggregate traffic on network logical ports. Token bucket capacity can be specified in bytes, and represented in 27-bit unsigned integer format to provide a maximum token bucket capacity of 128 MB. It will be appreciated that the capacity of the buckets associated with a port should be at least as large as the maximum packet length supported by the port such that a largest packet will always pass shaping conformity checks. Certain embodiments use a periodic credit increment technique for implementing token buckets for shaping such that, after a certain number of clock cycles, a programmable credit (the “refill credit”) is added to each token bucket. The token bucket algorithm rate is typically applied based on data traffic policing context and can be used by shaping control which is typically applied on a per port and per class of service basis.

In another example, shaping control can be applied on a per-flow basis such that a single shaping token bucket can be implemented to enforce the byte rate of the flow. In many embodiments, management packets sent by system processors are not subject to shaping and packets marked for dropping may not be processed by the shaper.

In certain embodiments, a differentiated services scheme is provided such that customer flows are observed and policed at ingress only and subsequently merged so that system resources can be shared up to and including an output port 26. Level 3 and level 2 scheduling functions can be rearranged from previously discussed examples such that level 2 scheduling is implemented as a strict priority scheme and level 3 implements DRR scheduling to facilitate the provision of differentiated services. Further, multiple scheduling classes per network port can be provided as described above. In one example, four scheduling classes can be assigned per network logical port for user packets such that each user flow can be mapped to a specific network logical port and scheduling class. In this example, the scheduler hierarchy can be changed to implement the following model for each network logical port:
The first level scheduler pick inserts management flows over any user flows mapped to the port
The second level scheduler picks between classes using a strict priority scheme, possibly combined with rate control (shaping)
The third level scheduler uses DRR between flows assigned to the port and the selected class.
   The combination of second and third level schedulers in the example can be viewed as having four DRR flow linked lists per port. This would allow reuse of existing DRR scheduling as explained below.

In the example, when the output port 26 makes a scheduling request, the scheduler may first check for any insert management packet awaiting service for that port. If so, the management packet is typically served ahead of any user packets. Otherwise, the scheduler selects the scheduling class that should be served next. The scheduler typically tracks whether a class has any packets awaiting service. Such determination can be made from the link count information of the linked lists of the scheduling classes.

One concern with strict priority scheduling between classes is that low priority classes can be starved for an extended. Even if high priority traffic is policed at the input, this may still happen due to bursts that the policing profiles may allow. Certain embodiments can limit the occurrence of starvation by providing strict priority per class scheduling combined with shaping. Assuming class 3 is the highest priority and class 0 has the lowest priority, the rate controlled strict priority class level scheduling model is as follows:
If class 3 has a packet and sending a packet from class 3 will not violate the rate limit of class 3, then class 3 is selected
Else if class 2 has a packet and sending a packet from class 2 will not violate the rate limit of class 3+2, then class 2 is selected
Else if class 1 has a packet and sending a packet from class 1 will not violate the rate limit of class 3+2+1, then class 1 is selected
Else if class 0 has a packet and sending a packet from class 0 will not violate the rate limit of class 3+2+1+0, then class 0 is selected
   This model allows lower priority classes to use bandwidth not used by higher priority classes but still limits the total bandwidth of higher priority classes so that lower priority classes do not starve.

For the purpose of implementing a model according to the latter described example, four shaping contexts can be provided for each network logical port. Each shaping context typically uses a single token bucket (to save system resources such as memory). The rate of each bucket can be configured as follows:
Bucket A rate will be configured to enforce the rate limit of class 3
Bucket B rate will be configured to enforce the rate limit of class 3+2
Bucket C rate will be configured to enforce the rate limit of class 3+2+1
Bucket D rate will be configured to enforce the rate limit of class 3+2+1+0

It will be apparent that certain conditions can control whether minimum bandwidth is guaranteed for each service class. For example:
Bucket A rate<Bucket B rate<Bucket C rate<Bucket D rate
Note that bucket 0 rate can be made equal to the line rate to allow class 0 traffic to provide access unused bandwidth by higher priority classes up to the link bandwidth. This scheme is not typically work-conserving unless, for performing conformance checks, the classes will be assigned to the buckets as follows:
Conformance of class 3 will be checked against bucket A
Conformance of class 2 will be checked against bucket B
Conformance of class 1 will be checked against bucket C
Conformance of class 0 will be checked against bucket D
   If a class is active and conformant to its assigned conformance bucket, and there are no higher priority classes that are active and conformant, then that class can be selected for service.

Conformance checking is typically based on assessing whether a bucket has positive credit rather than on a comparison of the bucket level to the packet length. It will be apparent that this would require negative credit support but provides the advantage that it avoids the need to know the length of the packet at the head of a class (i.e. at the head of the head flow in the link list of that class).

In many embodiments, the debiting of buckets can be configured through software which specifies those buckets to be debited when a packet from a particular class is selected for service. For example, to implement the above model, the debit buckets of each class will be as follows:
Class 3 will debit buckets A, B, C, D
Class 2 will debit buckets B, C, D
Class 1 will debit buckets C, D
Class 0 will debit bucket D

In certain embodiments, eight global profiles are provided for specifying service class to debit buckets mapping. Each network logical port is mapped to one of those profiles. This would allow implementation of other schemes such as one where each class can be guaranteed a minimum amount of bandwidth and but not allowed to exceed that bandwidth even if higher priority classes do not use their share.

Once a scheduling class is selected, the third level scheduler can use an enhanced DRR scheduling scheme such that the scheduler maintains one linked list of flows per class per network logical port. The flow entries are typically in a common memory with separate head pointer, tail pointer and link counter memories for each logical port. A common flow memory can be maintained, but the head pointer, tail pointer and link counter memories are typically maintained separately.

In certain embodiments, work-conserving features may be provided to permit transmission of packets ruled ineligible by a strict shaping scheme when capacity is available and no other packets are eligible. For example, it is possible that a particular class may be prevented from sending traffic due to shaping even if there are no active higher priority classes and no lower priority classes that are active and shaper conformant. It will be appreciated that such conditions can lead to undesirable system behavior in some embodiments, while in other embodiments, such behavior may be desirable to prevent transmission of certain classes of packets even when the system has unused capacity. Therefore, in certain embodiments, work-conserving features are provided in which an override is enabled by combinations of system condition and one or more configuration parameters to selectively enable and disable shaping functions on each class of each port. It will be appreciated that system condition can include performance measurements, load, capacity and error rates.

In certain embodiments, first, second and third level schedulers are implemented as virtual schedulers for execution on one or more physical state machines. In some embodiments, each port is associated with one or more virtual schedulers. State information related to virtual schedulers can be stored in memory. State information typically maintains a current state of scheduling for each virtual scheduler in the system, wherein the current state of scheduling includes location and status of queues, condition of deficit counters, available quanta and credits, priorities, guaranteed service levels, association of data flows with ports and other information associated with the virtual scheduler.

In certain embodiments, one or more state machines are provided to sequentially execute scheduling algorithms and control routines for a plurality of virtual schedulers. One or more pipelines can be used for sequencing scheduling operations. In one example, such pipelines can be implemented as hardware devices that provide state information to hardware state machines. In another example, at least a portion of a pipeline can be implemented in software using queues and data structures for ordering and sequencing pointers. It will be appreciated that, in certain embodiments, it may be preferable to provide a state machine for each scheduler while in other embodiments, a configurable maximum of virtual schedulers for each state machine may be configured. Certain embodiments provide a virtual scheduler to implement scheduling for one or more output ports. State machines can be implemented as combinations of hardware and software as desired.

Virtual schedulers typically operate in a hierarchical manner, with three levels of hierarchy. The virtual scheduler receive enqueue requests from the queuing engine and store packet length information. Upon enqueuing packets, virtual schedulers may also send one or more port-active signals to the port controller. Virtual schedulers typically update and maintain state information for associated output ports and schedule packets by sending corresponding packet length information for the port requested by the port controller. Virtual schedulers determine which class should be scheduled based on which class, if any, is conformant from both a port-shaping and flow-scheduling viewpoint.

Aspects of the subject matter described herein are set out in the following examples.

In certain embodiments, system and apparatus employs a method for scheduling data flows comprises steps that include selection of data packets in a plurality of data flows using a first scheduling scheme to obtain selected packets and scheduling the transmission of the prioritized packets using a second scheduling scheme to obtain scheduled packets. In some embodiments, one scheme of the first and second schemes prioritizes the data packets according to predetermined quality of service preferences and the other scheme operates as a weighted round robin scheduler having weighting factors for allocating bandwidth to portions of the prioritized packets. In some embodiments, additional steps are included for policing data flows at a point of ingress to the system and merging a plurality of the data flows. In some embodiments an additional included step adjusts the weighting factors to conform the content of the scheduled packets to a desired scheduling profile, whereby the factors and profile is configured by user, automatically configured or configured under software control. In some embodiments, weighting factors are associated with scheduling contexts which relate to combinations of network ports, scheduling classes and data flows. In many embodiments, data flows are assigned a service quantum that can be configured and measured as a selected number of transmission credits, and the service quantum is calculated based on weighting factors of one or more of the user flows and selected quantum scale factors associated with the network port.

In certain embodiments, a virtual queuing system for managing high density switches comprises combinations of priority based schedulers and round-robin scheduler executed by state machines. In certain embodiments, each state machine maintains a plurality of schedulers. In certain embodiments, each state machine provides data packets to a plurality of network ports. In certain embodiments, the system also comprises a shaper for regulating bandwidth among the plurality of data flows. In certain embodiments, the shaper is disabled under predetermined conditions to promote packet processing efficiency. In certain embodiments, state machines switch between scheduling and shaping operations for the ports and data flows by maintaining context and state information for each port and each data flow. In certain embodiments, the context and state information includes location and status of queues, condition of deficit counters, available quanta and credits, priorities, guaranteed service levels, association of data flows with ports and other information associated with the virtual scheduler. In certain embodiments, the shaper maintains one or more shaping contexts associated with each network port, data flow and scheduling class. In certain embodiments, the shaper employs a plurality of token buckets associated with the network ports, data flows and scheduling classes.

It is apparent that the embodiments described throughout this description may be altered in many ways without departing from the scope of the invention. Further, the invention may be expressed in various aspects of a particular embodiment without regard to other aspects of the same embodiment. Still further, various aspects of different embodiments can be combined together. Accordingly, the scope of the invention should be determined by the following claims and their legal equivalents

What is claimed is:

1. A method for scheduling data flows comprising the steps of:
sequencing data packets within a plurality of data flows according to a first characteristic to provide corresponding sequenced data flows;
selecting a next-in-sequence data flow to identify a transmittable data packet, wherein the next-in-sequence data flow is selected from the sequenced data flows according to a second characteristic; and
scheduling the transmittable data packet.

2. The method of claim 1 wherein the first characteristic is a strict priority scheduler.

3. The method of claim 1 wherein the first characteristic is a round robin scheduler.

4. The method of claim 1 wherein the second characteristic is a strict priority scheduler.

5. The method of claim 1 wherein the second characteristic is a round robin scheduler.

6. The method of claim 1 wherein the step of scheduling includes shaping transmitted data traffic for one or more selected ports and one or more classes of service.

7. The method of claim 1 wherein at least one of the first and second characteristics includes a weighted round robin scheduler for ordering data packets based in part on weighting factors associated with each of the data flows.

8. The method of claim 7 wherein the weighting factors are selected according to factors including a desired scheduling profile, system load and system configuration parameters.

9. The method of claim 7 wherein the weighting factors are associated with a scheduling context related to a predetermined configuration of network ports, scheduling classes and data flows.

10. The method of claim 6, and further comprising the step of computing a service quantum, wherein the service quantum is calculated based on the weighting factors and quantum scale factors associated with one or more network ports.

11. A virtual queuing system, comprising:
a priority-based scheduler;
a fairness-based scheduler; and
one or more state machines for executing the priority based scheduler and the round-robin scheduler, the one or more state machines being shared by a plurality of data flows,
wherein the priority-based scheduler and fairness-based scheduler are configured to sequence data packets for transmission from among a plurality of data flows, sequencing being based on a plurality of scheduling classes.

12. The system of claim 11 wherein the priority-based scheduler is for prioritizing data packets within a data flow and the fairness-based scheduler is for selecting one of the plurality of data flows to supply a data packet for transmission.

13. The system of claim 11 wherein the fairness-based scheduler is for prioritizing data packets within a data flow and the priority-based scheduler is for selecting one of the plurality of data flows to supply a data packet for transmission.

14. The system of claim 11 and further comprising an output scheduler for selecting between management data packets and data packets provided by a combination of fairness-based and priority-based schedulers.

15. The system of claim 11, wherein the state machine maintains information associated with one or more of the plurality of data flows, the information including location and status of queues, condition of deficit counters, available quanta and credits, priorities and service level selections.

16. The system of claim 11, and further comprising a shaper for regulating bandwidth allocation among the plurality of data flows.

17. The system of claim 16, wherein the one or more state machines is further for executing the shaper.

18. The system of claim 16, wherein the shaper maintains context associated with one or more network ports, one or more data flows and one or more scheduling classes.

19. The system of claim 16 wherein the shaper shapes using one or more token buckets.

20. A method for scheduling data flows comprising the steps of:
choosing a data flow from among a plurality of data flows to provide one or more data packets for transmission, wherein the chosen data flow is selected according to a first characteristic;
identifying a next data packet among the one or more data packets according to a second characteristic; and
controlling transmission of the next data packet,
wherein the first and second characteristics includes a strict priority scheduler and a round robin scheduler.
